(19) United States
(12) Patent Application Publication
(10) Pub. No.: US 2025/0367709 A1
(43) Pub. Date: Dec. 4, 2025

(54) ELECTROPLATING WAFER SEAL APEX CLEANING TOOL

(71) Applicant: APPLIED Materials, Inc., Santa Clara, CA (US)

(72) Inventors: Aaron Juntunen, Kalispell, MT (US); Gregory J. Wilson, Kalispell, MT (US)

(73) Assignee: APPLIED Materials, Inc., Santa Clara, CA (US)

(21) Appl. No.: 18/677,103

(22) Filed: May 29, 2024

(51) Int. Cl. B08B 1/14; B08B 1/20; B08B 1/30; B08B 3/04

(52) U.S. Cl. CPC B08B 1/14; B08B 1/20; B08B 1/30; B08B 3/04

(57) ABSTRACT

A cleaning apparatus for semiconductor equipment, the apparatus including a cleaning head having an attachment configured for removing contamination off an electroplating seal, the attachment including a base, a first protrusion located on a first side of the base, and a second protrusion located on a second side of the base opposite the first side, where the second protrusion comprises a flat portion and a sloped portion, wherein the second protrusion is configured to push an apex of the electroplating seal, and where the apex of the electroplating seal is configured for rotationally sliding along the second protrusion.

### BACKGROUND

Certain electroplating residues are difficult to remove from electroplating hardware and may degrade the useful life of electroplating hardware. The most common plating bath(s) chemistry which leaves a residue/contamination on elastomer seals for polyether ether ketone (PEEK) retainers (seals) is Tin (Sn) or Tin-Silver (Sn/Ag). For example, Sn baths may leave residues or films on electroplating equipment. One consequence of residue (or film) is a plate-up onto the elastomer seal surfaces. It is believed the residue creates a conductive film which can act as a seed layer to allow metal to plate on the chuck surfaces in addition to the wafer/workpiece. Also, if the seal is exposed to other plating baths (i.e. copper (Cu)), the Sn bath residue can be etched off into the Cu bath causing contamination of the Cu bath. Additionally, electroplating chemical residue can have negative impact on the electroplating process.

Accordingly, devices, systems, and methods of cleaning electroplating hardware, such as the apex of an elastomer seal, are needed.

### SUMMARY

Disclosed herein is a cleaning apparatus for semiconductor equipment, the apparatus including a cleaning head having an attachment configured for removing contamination off an electroplating seal, the attachment including a base, a first protrusion located on a first side of the base, and a second protrusion located on a second side of the base opposite the first side, where the second protrusion comprises a flat portion and a sloped portion, where the second protrusion is configured to push an apex of the electroplating seal, and where the apex of the electroplating seal is configured for rotationally sliding along the second protrusion.

In some embodiments, the cleaning head further comprises a pad that is at least partially located between the first protrusion and the second protrusion. In some embodiments, the second protrusion extends beyond the base.

In some embodiments, the flat portion is a first flat portion and the sloped portion is a first sloped portion, where the second protrusion further includes a second flat portion and a second sloped portion, and where the first flat portion and the second flat portion are separated by the second sloped portion.

In some embodiments, the sloped portion is a first sloped portion and the second protrusion further includes a second sloped portion that is separated from the first sloped portion by the flat portion.

In some embodiments, the attachment further comprises one or more base cutouts configured for increasing a lifetime of a pad.

In some embodiments, the cleaning head further comprises one or more cleaning head holes configured to couple the cleaning head to a swinging arm.

In some embodiments, the sloped portion has an offset from the flat portion of about 0.1 mm to about 3 mm. In some embodiments, end of the protrusion has an offset height of about 0.1 mm to about 1 mm.

In some embodiments, the cleaning apparatus further includes a swinging arm configured for holding the cleaning head in contact with the electroplating seal. In some embodiments, the cleaning apparatus further includes a pad secured onto the first protrusion and the second protrusion, where the pad is configured to contact at least the apex of the electroplating seal.

In some embodiments, the cleaning head exerts a radial force onto an outer surface of the electroplating seal and an upward force onto the apex of the electroplating seal. In some embodiments, the swinging arm is configured to bend when the second protrusion pushes the apex of the electroplating seal. In some embodiments, a bending offset of the swinging arm exerts an upward force onto the pad.

Also disclosed herein is a method of cleaning an electroplating seal including inserting the electroplating seal into a maintenance chamber, pushing the electroplating seal with a second protrusion of a cleaning head of the maintenance chamber, spinning the electroplating seal, bending a swinging arm of the maintenance chamber as the electroplating seal rides up a sloped portion of the second protrusion, and cleaning the electroplating seal with a pad secured onto at least a first protrusion of the cleaning head.

In some embodiments, bending the swinging arm applies an upward force on the pad. In some embodiments, contacting electroplating seal with the pad applies a radial force onto the pad. In some embodiments, the upwards force and the radial force clean an apex of the electroplating seal.

In some embodiments, the method further includes replacing the pad after a predetermined number of cycles. In some embodiments, the method further includes soaking the pad in a composition and securing the pad onto the first protrusion and the second protrusion.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1C show conventional elastomer seal, seal system, maintenance chamber, and cleaning heads, respectively.

FIGS. 1A-1E show conventional cleaning heads.

FIGS. 2A-2D are example cleaning heads, in accordance with the present technology;

FIGS. 3A-3B illustrate interactions between an example cleaning head and a maintenance chamber, in accordance with the present technology;

FIGS. 4A-4C illustrate cleaning pads interfacing with an elastomer seal, in accordance with the present technology;

FIGS. 5A-5E are different embodiments of cleaning heads, in accordance with the present technology;

FIGS. 6A-6B is another example cleaning head, in accordance with the present technology;

FIGS. 7A-7B is yet another example cleaning head, in accordance with the present technology;

FIG. 8 is a method of cleaning an electroplating seal, in accordance with the present technology;

FIG. 9 is another method of cleaning an electroplating seal, in accordance with the present technology; and

FIG. 10 is yet another method of cleaning and electroplating seal, in accordance with the present technology.

### DETAILED DESCRIPTION

Disclosed herein are apparatuses, systems, and methods for cleaning an elastomer seal (also referred to as an electroplating seal), including cleaning an apex of the elastomer seal. In some embodiments, a specialized cleaning head having an attachment with a first protrusion and a second protrusion holds a cleaning pad (or a pad for brevity) configured to clean the electroplating seal. A sloped portion of the second protrusion provides a guide rail for the elastomer seal as it is rotated in a cleaning apparatus. As the elastomer seal rotates, a swinging arm of the cleaning apparatus may bend downwards, thus applying an upwards force on the cleaning pad. Coupled with the radial force of the cleaning pad in the maintenance chamber, cleaning of the apex of the electroplating seal may be improved, which extends the life of the seal, prevents plate up (e.g., deposition of the unwanted materials) on the seal, and prevents additional plate up on other electroplating equipment, such as the seal system described herein.

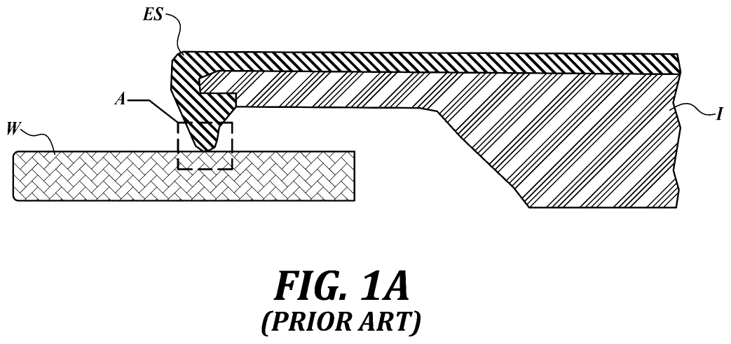

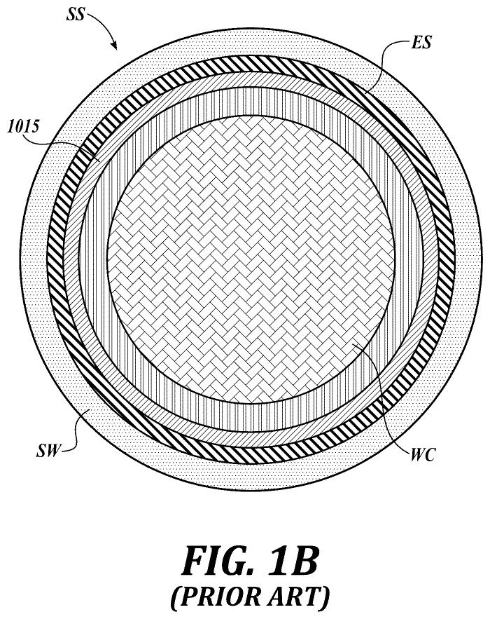

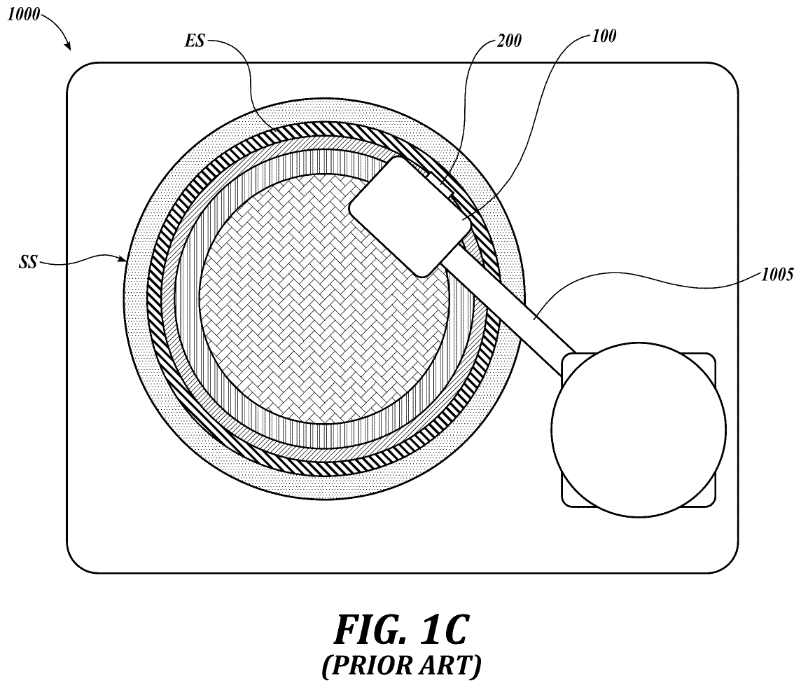

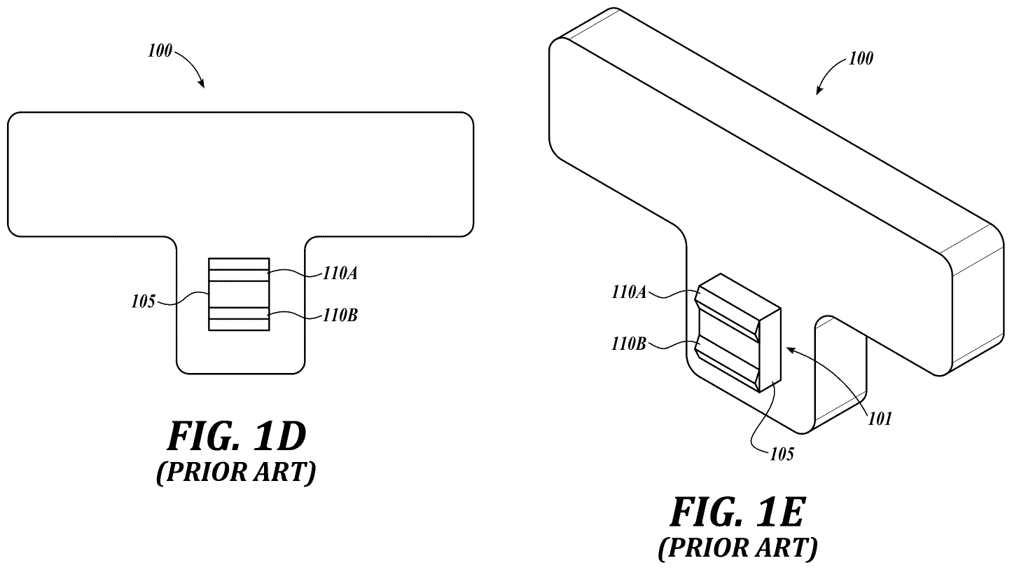

FIGS. 1A-1C show a conventional elastomer seal ES, seal system SS, maintenance chamber 1000, and cleaning heads 100.

FIG. 1A shows a conventional elastomer seal ES. The elastomer seal ES includes an apex region A (or “apex”) where the elastomer seal ES contacts a wafer W. A metal insert I is configured below the elastomer seal ES to provide additional structural integrity to the elastomer seal ES.

In operation, the elastomer seal ES operates as a gasket while the wafer W is electroplated. The elastomer seal ES may be a portion of a seal system SS, as shown in FIG. 1B.

FIG. 1B shows a conventional seal system SS. The seal system SS is cylindrical. A wafer (such as shown in FIG. 1A) is retained in a wafer chamber WC. The elastomer seal ES contacts the wafer and prevents it from moving during the electroplating process. Sidewalls SW surround the wafer and further retain the wafer during the electroplating process.

FIG. 1C is a simplified illustration of a conventional maintenance chamber 1000. An arm 1005 is configured to hold a cleaning pad 200 against the elastomer seal ES of the seal system SS. When placed in the maintenance chamber 1000, the seal system SS rotates, so that the cleaning pad 200 cleans the edge of the entire seal system SS.

FIGS. 1D-1E illustrate a conventional cleaning head 100. The cleaning head 100 is located on the arm (such as arm 1005) of the maintenance chamber (such as maintenance chamber 1000). The cleaning head 100 includes an attachment 101 having a base 105 and two protrusions 110A, 110B that extend from the base 105. A cleaning pad, such as shown in FIG. 1C, is placed onto the two protrusions 110A, 110B and is used to clean the elastomer seal (such as elastomer seal ES).

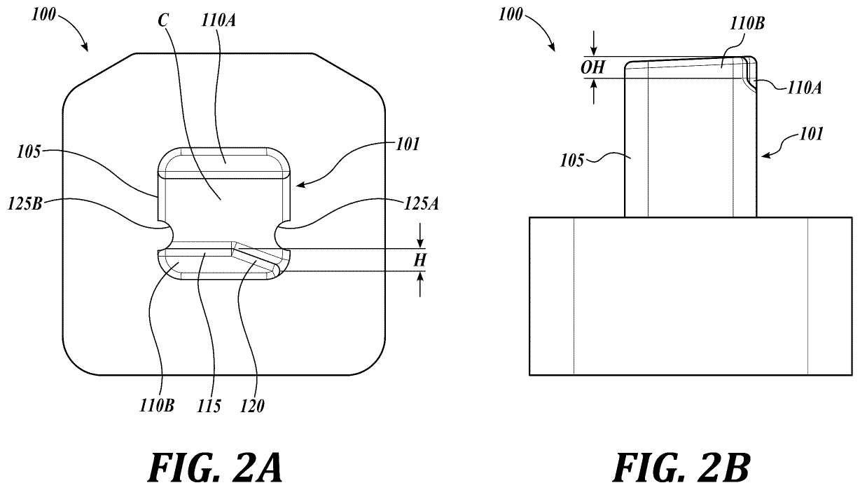

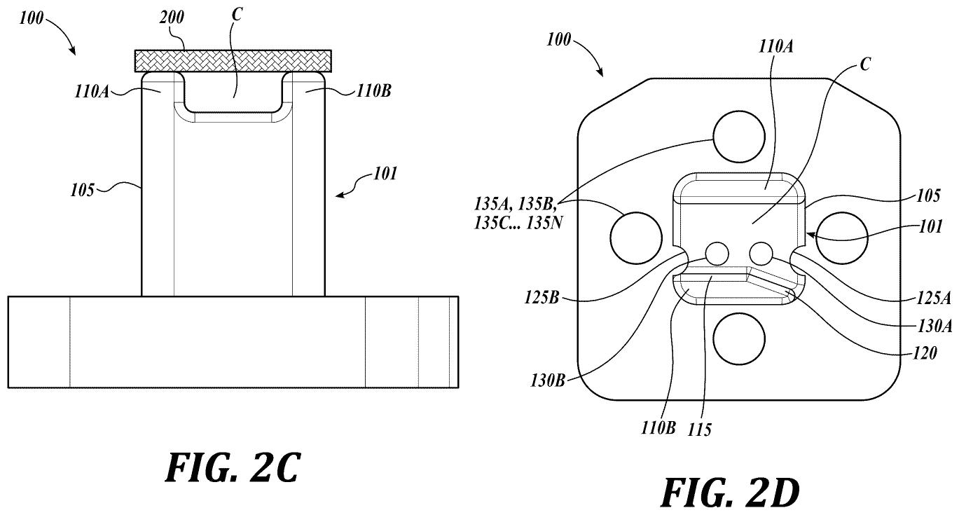

FIGS. 2A-2D are examples of cleaning apparatuses for semiconductor equipment, in accordance with the present technology. In some embodiments, the cleaning apparatus includes a cleaning head 100 having an attachment 101 configured for removing contamination off an electroplating seal (such as the electroplating seal of FIGS. 1A-1B). The attachment 101 may include a base 105, a first protrusion 110A located on a first side of the base 105, and a second protrusion 110B located on a second side of the base 105 opposite the first side. In some embodiments, the second protrusion 110B includes a flat portion 115 and a sloped portion 120. The second protrusion 110B may be configured to contact an apex of an electroplating seal (as shown in FIG. 1A). In some embodiments, the apex of the electroplating seal is configured for rotationally sliding along the second protrusion 110B. In the context of this Specification, a rotational sliding of the electroplating seal refers to a relative motion between the electroplating seal (which rotates) along the second protrusion 110B (along which the electroplating seal slides).

FIG. 2A is a front plan view of the example cleaning apparatus. FIG. 2B is a bottom plan view of the example cleaning apparatus. As shown, the base 105 protrudes from the cleaning head 100. Similarly, the first protrusion 110A and the second protrusion 110B protrude from the base 105. Accordingly, there is a cavity C between the first protrusion 110A and the second protrusion 110B.

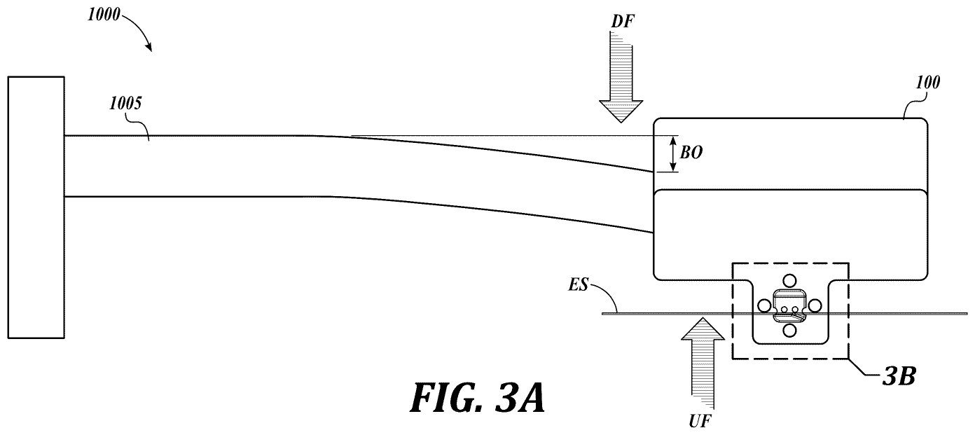

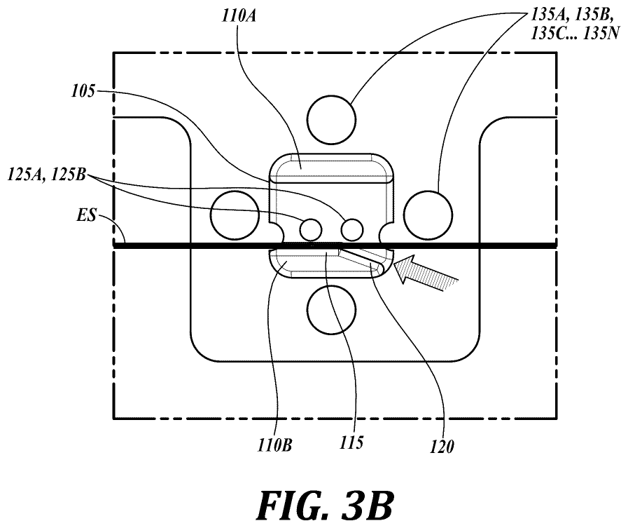

In some embodiments, the base 105 includes a first cutout 125A, and a second cutout 125B. In some embodiments, the first cutout 125A and the second cutout 125B are configured to allow a cleaning pad (such as pad 200 in FIG. 2C) to stretch, thereby reducing the force of an elastomer seal (such as elastomer seal ES in FIGS. 3A-3B) against the cleaning pad where the cutouts 125A, 125B are located. In some embodiments, the cutouts 125A, 125B increase the lifetime of the cleaning pad. Without cutouts 125A, 125B, the elastomer seal may wear through the cleaning pad quicker than if the cutouts 125A, 125B are present.

In some embodiments, the sloped portion 120 is characterized by an offset H. In some embodiments, the offset H is about 0.1 mm to about 3 mm. In some embodiments, an arm of a maintenance chamber, such as shown in FIG. 1C is configured to slide up the sloped portion 120. The offset H provides for a more gradual engagement between the apex of the electroplating seal and also for a more gradual bending of the swinging arm, as explained in more detail below. In some embodiments, the second protrusion 110B is also angled, having an offset height OH, as shown in the bottom view of FIG. 2B. In some embodiments, an end of the second protrusion 110B has an offset height OH of about 0.1 mm to about 1 mm.

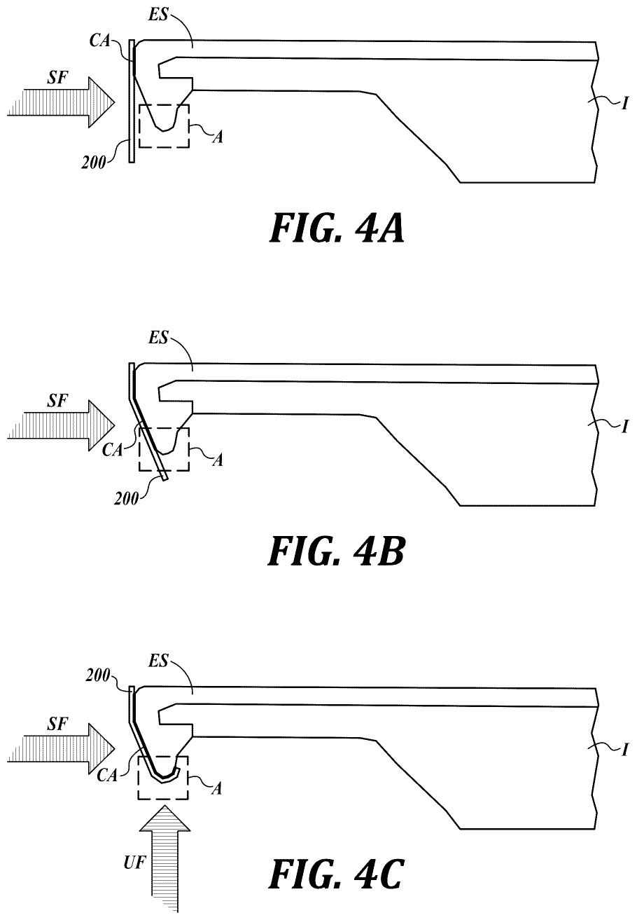

FIG. 2C is a side view of a cleaning head 100. In some embodiments, a cleaning pad 200 is placed onto the first protrusion 110A and the second protrusion 110B. In some embodiments, when the elastomer seal contacts the cleaning pad 200, the cleaning pad is pushed into the cavity C, as shown and described in detail in FIG. 4C. For simplicity and clarity of the drawings, the cleaning pad is generally not shown in the drawings for different embodiments of the attachment 101. A person of ordinary skill will understand that such cleaning pads may be mated with the attachment 101 even though not illustrated with respect to a particular attachment 101. Furthermore, also for the sake of simplicity and brevity, the present specification refers to the second protrusion 110b ‘contacting’ the apex of the elastomer seal ES whether the cleaning pad 200 is mated with the attachment 101 or not. A person of ordinary skill will also understand that, strictly speaking, if the cleaning pad 200 is present, then the second protrusion 110B actually contacts the cleaning pad 200 which in turn contacts the apex of the elastomer seal, while the second protrusion 110B pushes against both the cleaning pad 200 and the apex of the elastomer seal. Similar explanation, mutandis mutanda, applies in case of the base 105 ‘contacting’ the side of the elastomer seal ES through the cleaning pad 200.

FIG. 2D shows another example cleaning head 100 including one or more cleaning head holes 135A, 135B, 135C, 135N. In some embodiments, the cleaning head 100 further includes one of more base holes 130A, 130B. In some embodiments, the one or more cleaning head holes 135A, 135B, 135C, 135N are configured to couple the cleaning head 100 to a swinging arm (such as swinging arm 1005 in FIGS. 3A-3B). In some embodiments, the one or more base holes 130A, 130B are configures to allow for water to be passed to a cleaning pad (such as cleaning pad 200). In some embodiments, the water can pass through the one or more base holes 130A, 130B, wetting the cleaning pad. When the pad 200 contacts the elastomer seal, the pad 200 is sucked into the cavity C as air moves through the one or more base holes 130A, 130B.

FIGS. 3A-3B illustrate interactions between an example cleaning head 100 and a swinging arm 1005, in accordance with the present technology. In some embodiments, the cleaning apparatus 1000 includes a swinging arm 1005 configured for holding the cleaning head 100 in contact with the electroplating seal ES. In some embodiments, the cleaning apparatus 1000 is a maintenance chamber for a seal system (such as the seal system shown in FIG. 1C). It is believed that the apex of the electroplating seal ES may be a particularly important piece of the elastomer seal to clean, as contamination and plate up of the apex can lead to additional contamination of even unexposed portions of the elastomer seal. Improved cleaning of the apex of the electroplating seal ES is discussed below/

FIG. 3A is an example swinging arm 1005 bending as a cleaning head 100 contacts an elastomer seal ES. In some embodiments, the cleaning head 100 is attached to a swinging arm 1005 of a cleaning apparatus 1000. In some embodiments, the swinging arm 1005 is made of a flexible material. In such embodiments, the swinging arm may bend in response to a force exerted by the cleaning head 100. In some embodiments, the swinging arm 1005 bends to a bend offset BO when the cleaning head 100 contacts the elastomer seal ES. In this manner, the cleaning head 100 exerts a downward force onto the swinging arm 1005 and an upward force UF onto the elastomer seal ES. In this manner, an apex (such as apex A) of the elastomer seal ES is cleaned. The cleaning head 100 also applies a radial force onto the elastomer seal ES (as shown in FIG. 4C). As used herein, the term “radial” force means a sideways force applied as the elastomer seal ES rotates in a maintenance chamber.

FIG. 3B shows a closeup of the region 3B in FIG. 3A. In some embodiments, the cleaning head 100 includes a base 105, a first protrusion 110A, and a second protrusion 110B, where the second protrusion 110B includes a flat portion 115 and a sloped portion 120. In some embodiments, the cleaning head 100 includes one or more base holes 125A, 125B and one or more cleaning head holes 135A, 135B, 135C . . . 135N. While a cleaning head similar to that depicted in FIG. 1D is shown, it should be understood that any cleaning head illustrated and described herein could be substituted.

In operation, as the elastomer seal ES rotates inside the cleaning apparatus 1000, the swinging arm 1005 bends as the electroplating seal ES rides up a sloped portion 120 of the second protrusion 110B, and the electroplating seal ES is cleaned with a pad (not shown in FIG. 3B) that is secured onto the first protrusion 110B of the cleaning head 100 and the second protrusion 110B, as shown by the arrow in FIG. 3B. The second protrusion 110B helps the engagement of the electroplating seal ES and the cleaning head 100 by providing an easier entrance of the electroplating seal ES in the space between the first protrusion 110A and the second protrusion 110B.

FIGS. 4A-4C are pads 200 interfacing with an elastomer seal 2, in accordance with the present technology.

FIG. 4A is a simplified diagram of the cleaning area CA of a conventional maintenance chamber. As shown, conventionally, only a radial force SF is applied to the elastomer seal ES. This is because, in a conventional maintenance chamber, the pad 200 contacts only a side of the elastomer seal (electroplating seal) ES, illustrated as the cleaning area CA. Accordingly, the apex A of the elastomer seal ES is not cleaned.

FIG. 4B is a simplified diagram of the cleaning area CA of a maintenance chamber, in accordance with the present technology. In some embodiments, the cleaning head exerts a radial force SF greater than conventional maintenance chambers. In such embodiments, the cleaning area CA extends along the elastomer seal ES, but still cannot clean the apex A of the elastomer seal ES.

FIG. 4C is a simplified diagram of the cleaning area CA of a maintenance chamber, in accordance with the present technology. In some embodiments, a swinging arm (such as swinging arm 1005) bends as the elastomer seal ES rides up a sloped portion (such as sloped portion 120) of a second protrusion (such as second protrusion 110B). In this manner, the swinging arm applies an upward force UF to the cleaning pad 200, cleaning the apex A of the elastomer seal ES.

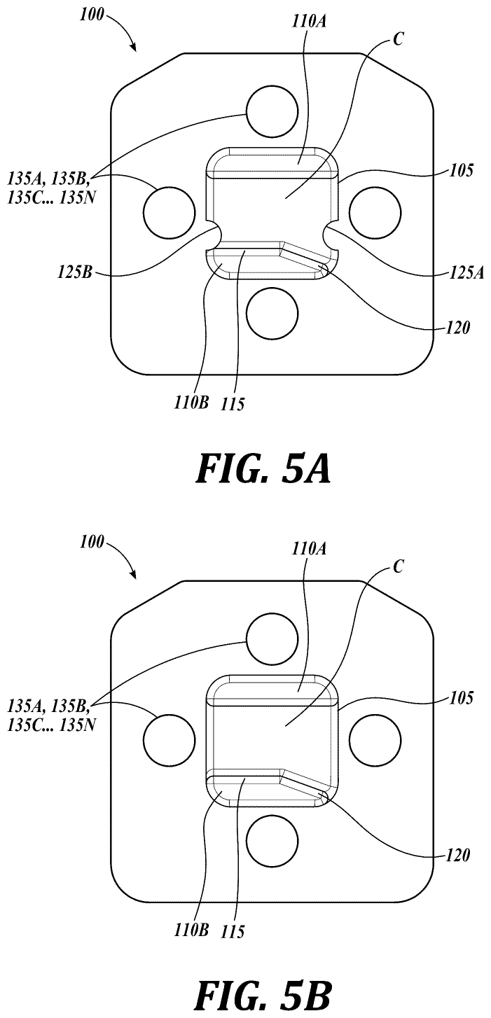

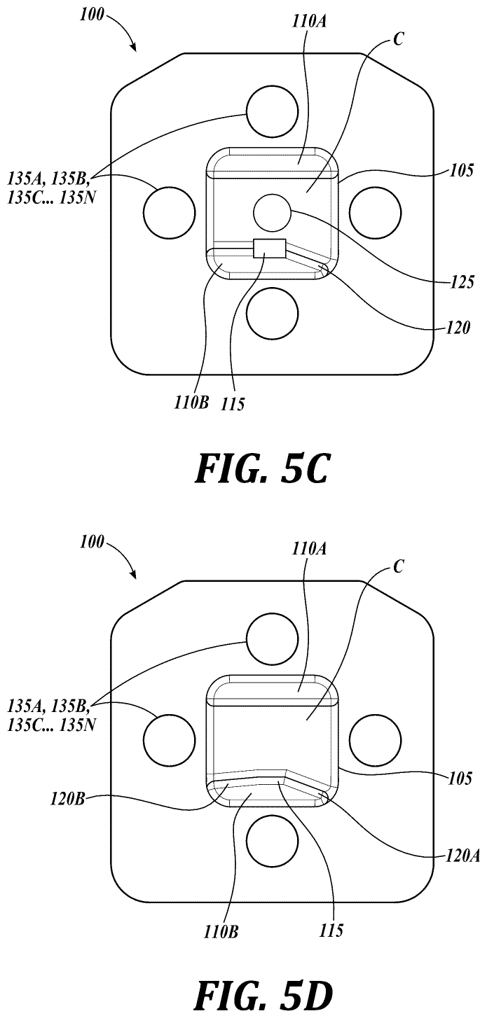

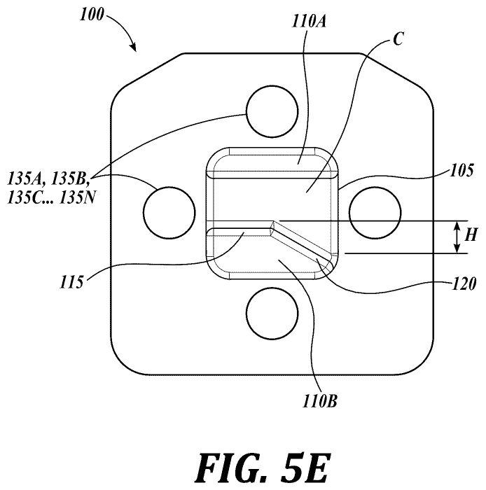

FIGS. 5A-5E are additional example cleaning heads 100, in accordance with the present technology. In some embodiments, the cleaning apparatus includes a cleaning head 100 having an attachment 101 configured for removing contamination off an electroplating seal (such as the electroplating seal of FIGS. 1A-1B). The attachment 101 may include a base 105, a first protrusion 110A located on a first side of the base 105, and a second protrusion 110B located on a second side of the base 105 opposite the first side. In some embodiments, the second protrusion 110B includes a flat portion 115 and a sloped portion 120. The second protrusion 110B may be configured to contact an apex of an electroplating seal (as shown in FIG. 3A). In some embodiments, the apex of the electroplating seal is configured for rotationally sliding along the second protrusion 110B. In operation, the apex of the electroplating seal ES first rides over the sloped portion 120 as the elastomer seal ES engages with the second protrusion 110B, and next the apex of the electroplating seal rides over the flat portion 115.

FIG. 5A shows an example cleaning head 100. In some embodiments, the base 105 includes a first cutout 125A, a second cutout 125B, and one or more cleaning head holes 135A, 135B, 135C . . . 135N.

FIG. 5B shows another example cleaning head 100. In some embodiments, the base 105 does not include cutouts (such as first cutout 125A and second cutout 125B). In some embodiments, the cleaning head 100 further includes one or more cleaning head holes 135A, 135B, 135C . . . 135N.

FIG. 5C shows yet another example cleaning head 100. In some embodiments, the base 105 includes only a single base hole 125. In some embodiments, the base hole 125 enables a reduced air resistance, such that a cleaning pad (such as cleaning pad 200, not shown) is sucked into the cavity C when contacting an elastomer seal ES.

FIG. 5D shows another example cleaning head 100. In some embodiments, the cleaning head 100 includes a second protrusion 110B having a flat portion 115, a first sloped portion 120A, and a second sloped portion 120B. In some embodiments, the sloped portion is a first sloped portion 120A and the second protrusion 110B further comprises a second sloped portion 120B that is separated from the first sloped portion 120A by the flat portion 115A. In some embodiments, an elastomer seal rides up the second sloped portion 120B and either rests on flat portion 115 or partially rides down first sloped portion 120A.

FIG. 5E shows yet another example cleaning head 100. In some embodiments, the base 105 does not include cutouts (such as first cutout 125A and second cutout 125B). In some embodiments, the cleaning head 100 further includes one or more cleaning head holes 135A, 135B, 135C . . . 135N. In some embodiments, the second protrusion 110B may have a thickness (height) larger than that of the first protrusion 110A. In some embodiments, the sloped portion 120 has an offset H of about 0.5 mm to about 3 mm.

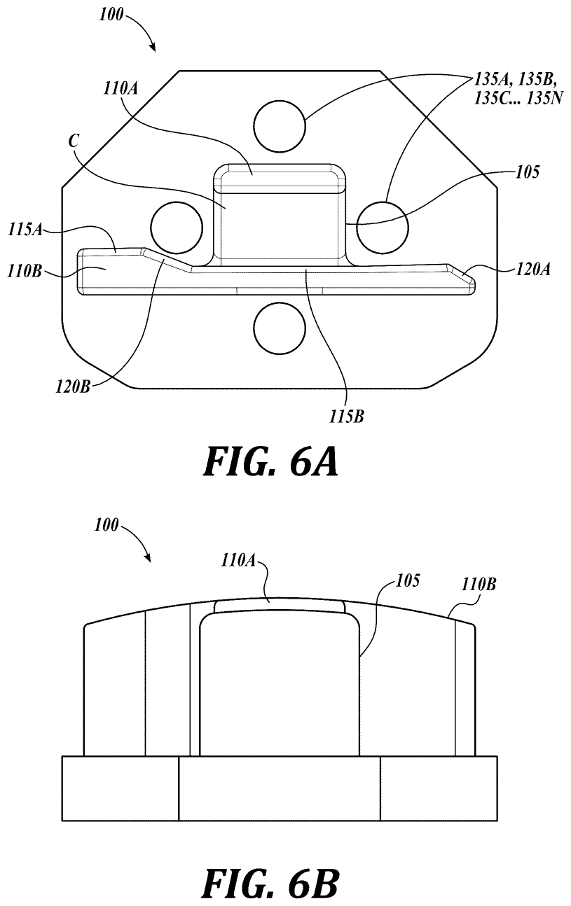

FIGS. 6A-6B are different views of another example cleaning head 100, in accordance with the present technology. FIG. 6A shows a front side of the cleaning head 100, while FIG. 6B shows a top-down perspective of the cleaning head 100. In some embodiments, the cleaning head 100 includes a base 105, a first protrusion 110A and a second protrusion 110B. In some embodiments, the second protrusion 110B extends past the base 105. In some embodiments, the flat portion is a first flat portion 115A and the sloped portion is a first sloped portion 120A, where the second protrusion 110B further includes a second flat portion 115B and a second sloped portion 120B. In some embodiments, the first flat portion 115A and the second flat portion 115B are separated by the second sloped portion 120B.

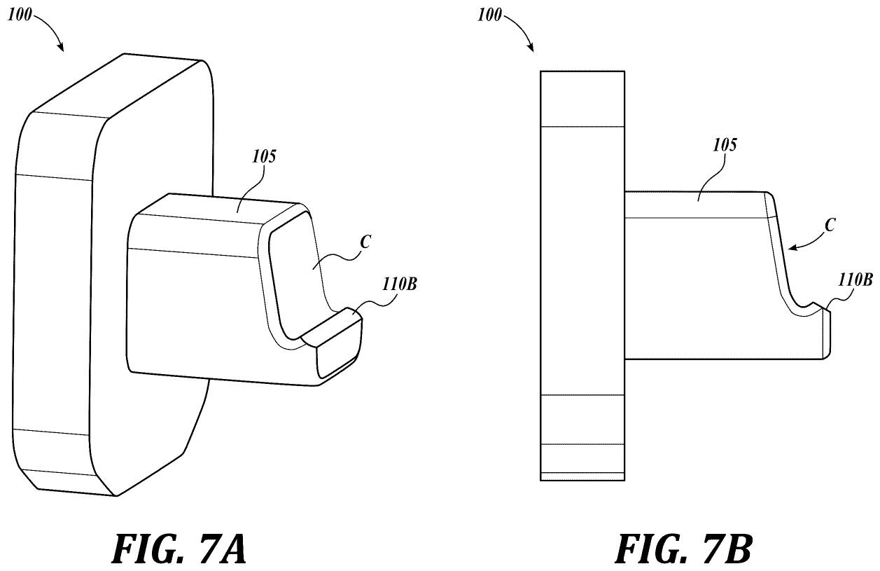

FIGS. 7A-7B are different views of yet another example cleaning head 100, in accordance with the present technology. In some embodiments, the cleaning head 100 includes a sloped attachment, referred to herein as a second attachment 110B. In some embodiments, the cavity C is the space that is formed between a first side of the base 105 and the second protrusion 110B. That is, the illustrated base 105 does not have the first protrusion 110A.

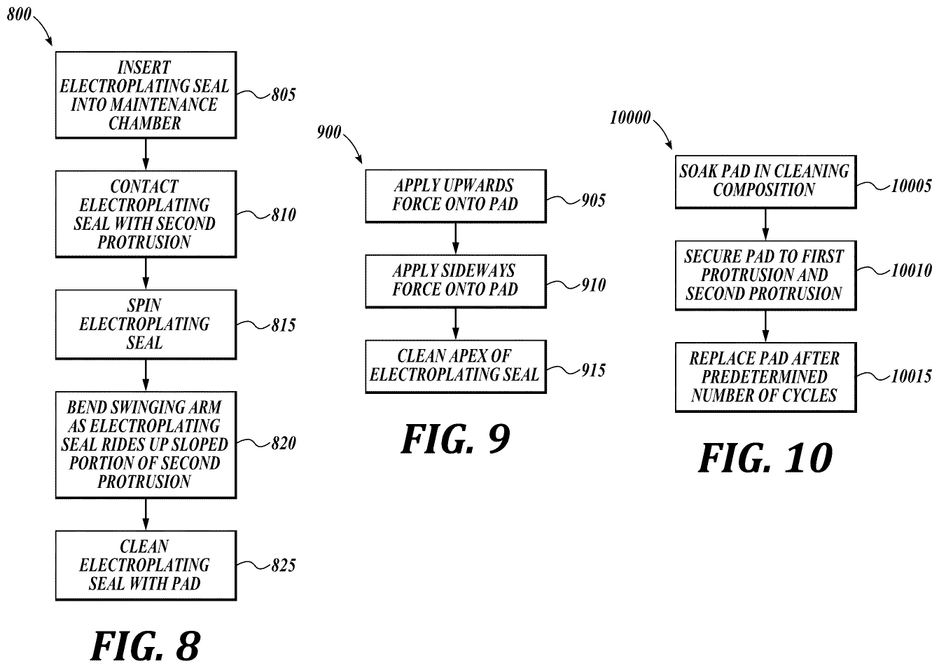

FIG. 8 is a method 800 of cleaning an electroplating seal, in accordance with the present technology. In some embodiments, the method 800 is carried out with a cleaning apparatus (such as cleaning apparatus 1000), for example, a maintenance chamber. In some embodiments, the cleaning apparatus is configured to clean an electroplating seal (such as elastomer seal ES). In some embodiments, the cleaning apparatus includes a cleaning head (such as cleaning head 100) having a base (such as base 105). In some embodiments, the base includes a first protrusion (such as first protrusion 110A) and a second protrusion (such as second protrusion 110B). including a flat portion (such as flat portion 115) and a sloped portion (such as sloped portion 120). In some embodiments, a pad (such as pad 200) is placed onto the first protrusion and the second protrusion.

In block 805, an electroplating seal is placed into the maintenance chamber. In some embodiments, the electroplating seal is an elastomer seal, as shown in FIG. 1A. In some embodiments, the electroplating seal is part of a seal system as shown in FIG. 1B.

In block 810, the electroplating seal is contacted with the second protrusion of the cleaning head. In some embodiments, the electroplating seal contacts the sloped portion of the second protrusion.

In block 815, the electroplating seal is spun. In some embodiments, the maintenance chamber is configured to rotate the electroplating seal clockwise and/or counterclockwise.

In block 820, the electroplating seal rides up the sloped portion of the second protrusion of the cleaning head. As the electroplating seal rides up, the swinging arm bends downwards. This bending of the swinging arm results in an upward force (such as upward force UP) being applied to the electroplating seal. In this manner, both a radial force (such as radial force SF) and the upward force are applied to the elastomer seal.

In block 825, the electroplating seal is cleaned with the pad located on the first and second protrusion. Because both the radial force and the upward force are applied, the maintenance chamber is able to clean an apex (as shown in FIG. 1A) of the elastomer seal, therefore reducing plate up at the apex.

FIG. 9 is another method 900 of cleaning an electroplating seal, in accordance with the present technology. In some embodiments, the method 900 is carried out with a cleaning apparatus (such as cleaning apparatus 1000), for example, a maintenance chamber. In some embodiments, the cleaning apparatus is configured to clean an electroplating seal (such as elastomer seal ES, elastomer seal 2, or the elastomer seal of FIGS. 1A-1B). In some embodiments, the cleaning apparatus includes a cleaning head (such as cleaning head 100) having a base (such as base 105). In some embodiments, the base includes a first protrusion (such as first protrusion 110A) and a second protrusion (such as second protrusion 110B). including a flat portion (such as flat portion 115) and a sloped portion (such as sloped portion 120). In some embodiments, a pad (such as pad 200) is placed onto the first protrusion and the second protrusion. In some embodiments, method 900 happens sequentially after method 800. In some embodiments, method 900 occurs contemporaneously with method 800.

In block 905, as the downwards force is applied onto the swinging arm, an upwards force is applied onto the pad.

In block 910, as the electroplating seal rotates, a radial force is applied onto the pad. In this manner both an upwards force and a radial force are applied to the pad.

In block 915, the apex of the electroplating seal is cleaned, as shown in FIG. 4C.

FIG. 10000 is yet another method of cleaning and electroplating seal, in accordance with the present technology. In some embodiments, the method 10000 is carried out with a cleaning apparatus (such as cleaning apparatus 1000), for example, a maintenance chamber. In some embodiments, the cleaning apparatus is configured to clean an electroplating seal (such as elastomer seal ES, elastomer seal 2, or the elastomer seal of FIGS. 1A-1B). In some embodiments, the cleaning apparatus includes a cleaning head (such as cleaning head 100) having a base (such as base 105). In some embodiments, the base includes a first protrusion (such as first protrusion 110A) and a second protrusion (such as second protrusion 110B). including a flat portion (such as flat portion 115) and a sloped portion (such as sloped portion 120). In some embodiments, a pad (such as pad 200) is placed onto the first protrusion and the second protrusion.

In block 10005, the pad is soaked in a cleaning composition. In some embodiments, the cleaning composition is a cleaning chemistry. In some embodiments, the cleaning composition is an alkaline cleaner, water, or an acid cleaner. In some embodiments, the cleaning chemistry is tin chemistry.

In block 10010, the pad is secured onto the first protrusion and the second protrusion. In some embodiments, the pad is placed onto the first protrusion and the second protrusion as shown in FIG. 2C, so that the pad is stretched over a cavity C of the attachment (such as attachment 101).

In block 10015, the pad is replaced after a predetermined number of cycles. In some embodiments, the predetermined number of cycles is about 10,000 to 15,000 cycles. In some embodiments, the predetermined number of cycles is about 20,000 to 30,000 cycles.

It should be understood that all methods 8000, 9000, and 10000 should be interpreted as merely representative. In some embodiments, process blocks of all methods 8000, 9000, and 10000 may be performed simultaneously, sequentially, in a different order, or even omitted, without departing from the scope of this disclosure.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

We claim:

1. A cleaning apparatus for semiconductor equipment, the apparatus comprising:
a cleaning head having an attachment configured for removing contamination off an electroplating seal, the attachment comprising:
a base;
a first protrusion located on a first side of the base; and
a second protrusion located on a second side of the base opposite the first side, wherein the second protrusion comprises a flat portion and a sloped portion, wherein the second protrusion is configured to push an apex of the electroplating seal, and wherein the apex of the electroplating seal is configured for rotationally sliding along the second protrusion.

2. The cleaning apparatus of claim 1, wherein the cleaning head further comprises a pad that is at least partially located between the first protrusion and the second protrusion.

3. The cleaning apparatus of claim 1, wherein the second protrusion extends beyond the base.

4. The cleaning apparatus of claim 1, wherein the flat portion is a first flat portion and the sloped portion is a first sloped portion, wherein the second protrusion further comprises a second flat portion and a second sloped portion, and wherein the first flat portion and the second flat portion are separated by the second sloped portion.

5. The cleaning apparatus of claim 1, wherein the sloped portion is a first sloped portion and the second protrusion further comprises a second sloped portion that is separated from the first sloped portion by the flat portion.

6. The cleaning apparatus of claim 1, wherein the attachment further comprises one or more base cutouts configured for increasing a lifetime of a pad.

7. The cleaning apparatus of claim 1, wherein the cleaning head further comprises one or more cleaning head holes configured to couple the cleaning head to a swinging arm.

8. The cleaning apparatus of claim 1, wherein the sloped portion has an offset from the flat portion of about 0.1 mm to about 3 mm.

9. The cleaning apparatus of claim 1, wherein an end of the protrusion has an offset height of about 0.1 mm to about 1 mm.

10. The cleaning apparatus of claim 1, further comprising
a swinging arm configured for holding the cleaning head in contact with the electroplating seal.

11. The cleaning apparatus of claim 10, further comprising:
a pad secured onto the first protrusion and the second protrusion, wherein the pad is configured to contact at least the apex of the electroplating seal.

12. The cleaning apparatus of claim 11, wherein the cleaning head exerts a radial force onto an outer surface of the electroplating seal and an upward force onto the apex of the electroplating seal.

13. The maintenance chamber of claim 11, wherein the swinging arm is configured to bend when the second protrusion pushes the apex of the electroplating seal.

14. The maintenance chamber of claim 11, wherein a bending offset of the swinging arm exerts an upward force onto the pad.

15. A method of cleaning an electroplating seal comprising:
inserting the electroplating seal into a maintenance chamber;
pushing the electroplating seal with a second protrusion of a cleaning head of the maintenance chamber;
spinning the electroplating seal;
bending a swinging arm of the maintenance chamber as the electroplating seal rides up a sloped portion of the second protrusion; and
cleaning the electroplating seal with a pad secured onto at least a first protrusion of the cleaning head.

16. The method of claim 15, wherein bending the swinging arm applies an upward force on the pad.

17. The method of claim 16, wherein contacting electroplating seal with the pad applies a radial force onto the pad.

18. The method of claim 17, wherein the upwards force and the radial force clean an apex of the electroplating seal.

19. The method of claim 15, further comprising replacing the pad after a predetermined number of cycles.

20. The method of claim 15, further comprising:
soaking the pad in a composition; and
securing the pad onto the first protrusion and the second protrusion.
